(19) United States
(12) Patent Application Publication
(10) Pub. No.: US 2025/0144591 A1
(43) Pub. Date: May 8, 2025

(54) FLOW PACKED-BED PHOTOREACTOR WITH GAS-LIQUID SEPARATION FOR PHOTOCATALYTIC HYDROGEN PRODUCTION

(71) Applicant: North Carolina State University, Raleigh, NC (US)

(72) Inventors: Malek Y.S. Ibrahim, Cairo (EG); Milad Abolhassani, Apex, NC (US)

(21) Appl. No.: 18/832,658

(22) PCT Filed: Mar. 23, 2023
(86) PCT No.: PCT/US2023/064843

§ 371 Date: Jul. 24, 2024

Related U.S. Application Data
(60) Provisional application No. 63/323,214, filed on Mar. 24, 2022.

(51) Int. Cl. B01J 19/12; B01J 8/06; B01J 19/24; C01B 3/26

(52) U.S. Cl. CPC B01J 19/123; B01J 8/06; B01J 19/127; B01J 19/2475; C01B 3/26; B01J 2219/00033; B01J 2219/0892; C01B 2203/1064; C01B 2203/1082

(57) ABSTRACT

The present disclosure relates to a photoreactor and method of use thereof. In an aspect, the photoreactor can be configured as a solar panel comprising a channel containing a heterogeneous photocatalyst. When water or another hydrogen-containing liquid is pumped through the photoreactor, it contacts the photocatalyst in the presence of UV or visible irradiation, simultaneously releasing hydrogen and separating the hydrogen via a gas-permeable membrane. In an aspect, the photoreactor can be used in a method for continuous production of high-purity H₂ gas, the method comprising dehydrogenating tetrahydroquinoline (THQ) to form quinoline under visible light using a Rh/TiO₂ heterogeneous photocatalyst. In another aspect, the catalyst includes Rh particles photodeposited on TiO₂ microparticles. In a further aspect, the method can include regenerating THQ from quinoline using a water gas shift (WGS) reaction.

### CROSS-REFERENCE TO RELATED APPLICATIONS

This application claims the benefit of U.S. Provisional Application No. 63/323,214, filed on Mar. 24, 2022, which is incorporated herein by reference in its entirety.

### BACKGROUND

Stringent regulations on carbon emissions are expected in the near future because of the accelerating negative environmental impacts of global warming. Renewable energy sources including solar, wind, and biomass are attractive alternatives to fossil fuels that will help reduce worldwide carbon emissions. However, the intermittent nature of these alternative energy sources necessitates the development of green and sustainable energy storage and transportation technologies to maintain constant power supply. Hydrogen (H₂) is a clean and high-density form of energy storage that can be directly used in internal combustion engines and fuel cells. The existing fuel storage and distribution infrastructure are designed to handle liquid fuels and thus storing H₂ in the form of liquid organic hydrogen carrier (LOHC) would allow for facile retrofitting of current global infrastructure for H₂ economy.

Over the past decade, several catalytic processes have been developed for H₂ generation and storage. However, the energy consumption and cost of generation and storage of H₂, including the water electrolysis (>$5/Kg), extreme conditions required, such as, for example, high pressures and the high temperature water gas shift (WGS) reaction (>400° C.), and/or the cost of the H₂ storage/release process (>$1/kg) hamper the overall feasibility of the process.

N-substituted heterocycles have lower dehydrogenation energy barriers when compared to cycloalkanes, and thus provide a low energy opportunity for H₂ release. However, catalyst stability and recycling issues can further complicate the design of these processes. Heterogeneous dehydrogenation catalysts that operate at temperatures higher than 120° C. and contain precious metal supported nanoparticles have been developed to address this issue at yields exceeding 95%. In one example, Deraedt et al. have shown that the dendrimer-stabilized nanoparticles of palladium (Pd), platinum (Pt), and rhodium (Rh) supported on SBA-15 silica can drive the dehydrogenation of 1,2,3,4 tetrahydroquinoline (THQ) to completion in 23 h at 130° C. In another study, Cui et al. have demonstrated that Pd₃Au₁ nanoparticles supported on carbon nanotubes could reduce the THQ dehydrogenation time by ˜50% (12 h) at a slightly higher temperature (140° C.) and at a lower catalyst loading. Non-precious metal catalysts have also been investigated to overcome the high cost of the precious metals. For example, it has been demonstrated that iron (Fe) could achieve dehydrogenation of THQ in 18 h at 145° C., but at a lower yield (88%) than that obtained by precious metals.

From a sustainability perspective, a more energy efficient acceptorless dehydrogenation process relies on the photo activation of the catalyst. Metal organic frameworks (MOFs) with narrow distance between their active sites have been shown to catalyze the dehydrogenation of THQ in 3 h under ultraviolet (UV) illumination (390 nm). When catalysts can be activated by visible light, readily available solar irradiation can also be utilized to further increase the efficiency of the dehydrogenation process. Hexagonal boron carbon nitride (h-BCN) catalyst has been demonstrated to dehydrogenate THQ with blue light (420 nm) in 12 h at 79% yield. In a recent study by Balayeva et al., THQ dehydrogenation yields up to 99% have been achieved with Rh supported on anatase Hombikat titania (TiO₂) particles (ca. 1 μm particles) in 24 h with blue light (453 nm max.). The ability to harvest visible light with TiO₂ is attributed to the ligand to metal charge transfer (LMCT) that occurs in the surface complex formed when the THQ amine coordinates to the surface of Ti4+Lewis acid site. The Rh nanoparticles provide the metallic surface needed for recombinative desorption of H₂ in this case. Thus far, such processes have only been tested on a small scale.

The thermo- and photo-catalytic acceptorless dehydrogenation catalysts are conventionally tested in batch stirred reactors that require oxygen removal from the head space, generate catalyst fines, and require filtration/centrifugation for catalyst recycling, resulting in additional challenges when attempting to scale up the process. Moreover, batch reactors exhibit low surface area to volume ratio which limits the ability to effectively harvest solar light. Microscale flow chemistry platforms with their high surface area to volume ratios, have recently been demonstrated to successfully enable challenging chemical transformations, including homogeneous photocatalytic reactions. However, heterogeneous photocatalytic microreactors are largely undeveloped.

An ideal solution would involve dehydrogenation of THQ to quinoline using a Rh/TiO₂-catalyzed reaction, wherein catalysis is promoted by illuminating the catalyst and reactants with visible light. A reverse reaction under mild conditions (<100° C.) would involve H₂ transfer from water to quinoline liquid phase WGS reaction. In some aspects, such a process would be highly efficient (>98% yield) with the addition of no more than simple auxiliary chemicals such as short-chain tertiary amines. Furthermore, in an ideal process and reactor, continuous dehydrogenation of THQ could occur at room temperature under low pressure drop (<60 psig). In any of these aspects, selective photodeposition of Rh into a flow reactor post-packing on the outer surface of TiO₂ microparticles available to photon flux reduces optimal Rh loading by 10 times compared to a batch reactor. In another aspect, only low amounts of Rh would be required (about 0.025 wt % in some embodiments), and the dehydrogenation catalyst would be stable under continuous flow conditions for more than 72 h after which it could be regenerated by flowing aerated water under visible light irradiation. In still another aspect, the ease of fabrication of the developed photocatalytic microreactor would make it amenable to scaling up. The present disclosure addresses these needs.

### SUMMARY

The present disclosure relates to a photoreactor and method of use thereof. In an aspect, the photoreactor can be configured as a solar panel comprising a channel containing a heterogeneous photocatalyst. When water or another hydrogen-containing liquid is pumped through the photoreactor, it contacts the photocatalyst in the presence of UV or visible irradiation, simultaneously releasing hydrogen and separating the hydrogen via a gas-permeable membrane. In an aspect, the photoreactor can be used in a method for continuous production of high-purity H₂ gas, the method comprising dehydrogenating tetrahydroquinoline (THQ) to form quinoline under visible light using a Rh/TiO₂ heterogeneous photocatalyst. In another aspect, the catalyst includes Rh particles photodeposited on TiO₂ microparticles. In a further aspect, the method can include regenerating THQ from quinoline using a water gas shift (WGS) reaction.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a schematic illustration of the low temperature quinoline hydrogenation under WGS conditions and the photocatalytic tetrahydroquinoline dehydrogenation in a photo-flow reactor packed with Rh/TiO₂ catalyst.

FIG. 2 shows quinoline yield and volumetric flowrate of the released H₂ from the continuous photocatalytic acceptorless THQ dehydrogenation process in the flow reactor under variable Rh loading. Photo flow reactor: FEP tubing with an outer diameter of ⅛″, inner diameter of 1/16″, and length of 25 cm. Liquid flowrate=3 L/min of 0.1 M THQ solution in IPA. Light source: 427 nm blue light at 55 mW/cm² light intensity.

FIGS. 3A-3D show effects of (FIG. 3A) THQ concentration, (FIG. 3B) feed flow rate, (FIG. 3C) light intensity, and (FIG. 3D) peak emission wavelength on the quinoline yield and released H₂ volumetric flowrate from the photo flow reactor packed with 0.025 wt % Rh/TiO₂ catalyst. Photo flow reactor: FEP tubing with an outer diameter of ⅛″, inner diameter of 1/16″, and length of 25 cm. Liquid flowrates in A, C, and D=3 μL/min. THQ concentration in FIGS. 3B-3D=0.1 M in IPA. Light source peak emission wavelength in FIGS. 3A-3C=427 nm. Light intensity 55 mW/cm², unless otherwise mentioned in FIG. 3C.

FIG. 4A shows stability of the packed-bed photo flow reactor in terms of the quinoline yield and H₂ product volumetric flowrate using 0.025 wt % Rh/TiO₂ catalyst. Photo flow reactor: FEP tubing with an outer diameter of ⅛″, inner diameter of 1/16″, and length of 25 cm. Liquid flowrate=3 μL/min. THQ concentration=0.1 M in IPA. Light source peak emission wavelength=427 nm blue light at 55 mW/cm² intensity. FIG. 4B shows formation of a brown residue on the dehydrogenation photocatalytic flow reactor on the inlet side after 60 h of operations. FIG. 4C shows regeneration water effluent collected at different times from starting regeneration from left to right.

FIGS. 5A-5D show effects of (FIG. 5A) auxiliary amine structure, (FIG. 5B) solvent, (FIG. 5C) dimethylamine volumetric ratio, and (FIG. 5D) water volumetric ratio on the THQ yield from 0.3 M quinoline hydrogenation under the WGS conditions in MeOH solvent at 80° C., 350 psig CO pressure, and 1 mol % [Rh(COD)Cl]₂.

FIGS. 6A-6B show two exemplary packed photoreactors for performing continuous in-flow photocatalysis and liquid gas separation.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Continuous production of H₂ is highly desirable in numerous fields where renewable and carbon-free energy is desired, including transportation, aerospace, portable power systems, fuel cells, and the like. The present disclosure provides for continuous H₂ production from tetrahydroquinoline (THQ) and regeneration of the same using a water gas shift (WGS) reaction. Both dehydrogenation of THQ and regeneration of THQ from quinoline can be carried out under mild conditions.

In an aspect, the dehydrogenation of THQ or another liquid hydrogen carrier can be carried out continuously to produce a stream of H₂. Further in this aspect, when THQ is the liquid hydrogen carrier, the THQ can be dehydrogenated to quinoline. In one aspect, the hydrogen can be high purity, wherein high purity is from about 98% pure to about 99.9% pure on a dry basis. In a further aspect, the dehydrogenation reaction can be carried out in a reactor as described herein. In one aspect, the method can be conducted under UV or visible light having a wavelength of between about 200 nm and about 750 nm, or between about 300 nm and about 500 nm, between 400 nm and about 450 nm, or between about 425 nm and about 440 nm. Further in this aspect, the visible light can have an intensity of from about 10 mW/cm² to about 150 mW/cm², or from about 40 to 55 mW/cm², 45 to 50 mW/cm², or about 50 to 55 mW/cm².

In any of these aspects, the dehydrogenation of THQ can be enhanced or enabled by a catalyst such as, for example, a heterogeneous photocatalyst or a metal-free catalyst. In one aspect, when a metal-free catalyst is used, the catalyst can include graphene, carbon nitride, or any combination thereof.

In another aspect, when a heterogeneous catalyst is used, the heterogeneous photocatalyst can be or include one or more transition metal clusters photodeposited on semiconductor nanoparticles. In a further aspect, the semiconductor nanoparticles can include a metal oxide, a metal nitride, a metal sulfide, or any combination thereof. In an aspect, the metal oxide can be TiO₂, BaTiO₃, BiVO₄, or any combination thereof.

In any of these aspects, the heterogeneous photocatalyst can include a dopant such as, for example, Fe, Cu, Pd, Pt, Ru, Au, Ag, Rh, another transition metal, or any combination thereof.

In one aspect, the catalyst can be an Rh/TiO₂ heterogeneous photocatalyst. In a further aspect, the TiO₂ in the catalyst can be present as anatase TiO₂ microparticles, wherein the microparticles have a diameter of from about 1 μm to about 1000 μm, from about 10 μm to about 500 μm, from 100 μm to about 250 μm, or from about 100 to 150 μm, about 150 to about 200 μm, about 200 to 250 μm, or about 175 to about 225 μm. In a further aspect, the Rh can be photodeposited on the anatase TiO₂ microparticles and may be present in an amount of from about 0 wt % to about 2 wt % relative to the total amount of and TiO₂ present in the catalyst, or at from about 0.025 to about 1 wt %, about 0.025 to about 0.05 wt %, or about 0.025 to about 0.04 wt %.

In one aspect, THQ dehydrogenation can be accomplished in less than about 3 hours, or less than about 2 hours, or less than about 1 hour. In any of these aspects, a pressure drop of less than about 2 psi/cm can be maintained during dehydrogenation. In all of these aspects, the dehydrogenation can be carried out at a mild temperature such as, for example, from about 5° C. to about 65° C., from about 20° C. to about 40° C., from about 25° C. to about 25° C., from about 40° C. to about 60° C., or from about 50° C. to about 60° C. In another aspect, the method can be conducted under an air atmosphere or an argon atmosphere. In another aspect, a space time yield for THQ dehydrogenation can be at least about 26.5 gH₂/L·h at a THQ concentration of about 0.1 M.

In any of these aspects, THQ can be regenerated from quinoline using catalytic hydrogenation, electrochemical hydrogenation, a water gas shift (WGS) reaction, or another process. In some aspects, the quinoline is neat or is present in a solution, wherein the quinoline is dissolved in a solvent at a concentration of, for example, 0.3 M. In a further aspect, the solvent can be isopropyl alcohol, methanol, ethanol, n-butanol, i-butanol, cyclohexanol, ethoxyethanol, water, ammonia, formic acid, acetic acid, or any combination thereof. In some aspects, an auxiliary amine is also present. In one aspect, the auxiliary amine can be selected from triethylamine (TEA), N-methylpyrrolidine, dimethylethylamine (DMEA), methyldiethylamine, dimethylpropylamine, N-methylpiperidine, or any combination thereof. In one aspect, non-hindered auxiliary amines may be preferred. In a further aspect, the auxiliary amine can increase the pH of the reaction medium, ligate the Rh catalyst, scavenge CO₂ byproducts, or any combination thereof.

In one aspect, the regeneration of THQ by WGS reaction can be conducted in a batch reactor or a segmented flow reactor, and may further include use of a catalyst such as, for example, a rhodium catalyst. In one aspect, the rhodium catalyst can be selected from Rh(COD)Cl]₂, Rh(COD)₂BF₄, or any combination thereof and can be present in an amount of from about 1 mol % to about 2 mol %, from about 1 to about 1.5 mol %, about 1.5 to about 2 mol %, or from about 1.25 to about 1.75 mol %. In some aspects, the solution of quinoline in the WGS reaction may further include an additive such as, for example, Csl, CsBr, KI, LiCl, benzoic acid, or any combination thereof.

In any of these aspects, the WGS reaction can be conducted at mild conditions. In one aspect, the WGS reaction may be conducted under a carbon monoxide atmosphere at about from about 75° C. to about 150° C., or from about 80 to about 125° C., or from about 80 to about 90° C. In another aspect, the WGS reaction, when carried out for from about 3 h to about 15 h, from about 3 h to about 12 h, or from about 5 h to about 10 h, has a yield of at least 90% or greater THQ.

Also disclosed herein are photoreactors for gas-liquid separation. In one aspect, the photoreactors can be used for the disclosed reactions or for other reactions where gas-liquid separation may be required. In an aspect, the photoreactor includes at least one photoreactor bed packed with an semiconductor photocatalyst such as the Rh/TiO₂ catalyst or any other photocatalyst disclosed herein, wherein the photoreactor bed includes a material transparent to visible light as well as a liquid inlet, catalyst flow resistor, and a gas outlet.

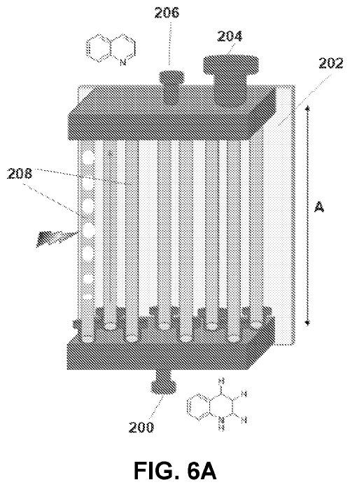

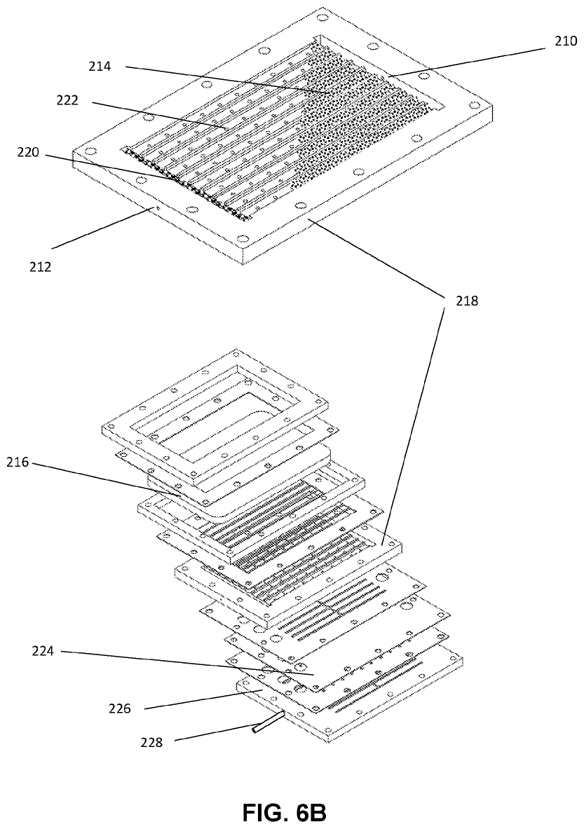

Various arrangements of photoreactor components are envisioned and should be considered disclosed. In one aspect, at least one photoreactor can be formed in the shape of a tube, and the photoreactor can include a plurality of identical photoreactor beds arranged in parallel. In one aspect, the at least one photoreactor bed includes at least one channel, wherein the at least one channel is packed with a catalyst as described herein, such as a heterogeneous photocatalyst or metal-free catalyst. Further in this aspect, a first manifold chamber can connect the liquid inlet to a photoreactor bed inlet for each individual photoreactor bed of the plurality, and a second manifold chamber can connect a photoreactor bed outlet for each individual photoreactor bed of the plurality to the liquid effluent. In another aspect, the photoreactor can further include a reflective material on one side of the photoreactor such as shown in FIG. 6A behind the plurality of beds, where the beds can have a tubular shape or another shape. In one aspect, the tubes or a portion thereof are made from the material transparent to visible light, such that the catalyst packed into the beds is exposed to UV and/or visible light. In another aspect, the tubes can include a gas-permeable transparent membrane for continuous release of hydrogen as it is produced.

In an alternative aspect, the at least one photoreactor bed can have a flat rectangular shape and can include a top plate and a bottom plate. Further in this aspect, the top plate includes the material transparent to visible light, while the bottom plate includes a liquid channel or a plurality of channels packed with the catalyst, such that the catalyst in the liquid channel is exposed to visible light. Further in this aspect, the top plate can withstand up to 30 bar internal pressure. In some aspects, the photoreactor can further include a gas permeable membrane disposed on a membrane support. In an aspect, the gas permeable membrane allows for immediate and continuous separation of H₂ as it is produced. FIG. 6B depicts an exemplary reactor having this arrangement of parts.

In any of these aspects, the reactor can further include a gas collection chamber. In one aspect, the gas collection chamber can be transparent. In another aspect, the gas collection chamber surrounds the photoreactor and, by being transparent, allows visible light to pass through and interact with the catalyst in the photoreactor beds.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Herein is disclosed an energy-efficient photocatalytic dehydrogenation strategy for continuous production of high-purity H₂ gas under visible light in a packed-bed photo flow reactor using a rhodium (Rh)/titania (TiO₂) heterogeneous photocatalyst. In one aspect, the tradeoff between the reactor pressure drop and its photocatalytic surface area is resolved by performing the photodeposition of Rh post-packing, which allows for selective Rh deposition on the outer surface of the TiO₂ microparticles available to photon flux and thus reduces the optimal Rh loading by 10 times when compared to Rh deposition pre-packing in a batch reactor. Utilizing the developed packed-bed photo flow reactor, a complete tetrahydroquinoline dehydrogenation can be achieved in flow in less than 3 h residence time with released H₂ flowrates exceeding 1 mln/h in a single microtube. The pressure drop is maintained at 2 psig/cm by utilizing relatively coarse TiO₂ particles (100-250 μm diameter) and as a side effect of the formation of compressible hydrogen bubble inside the reactor.

It is also demonstrated herein that quinoline can be hydrogenated back to tetrahydroquinoline by direct H₂ transfer from water under the Water-Gas Shift (WGS) reaction conditions in a single step at 80° C. in a presence of dimethylethylamine and Rh catalyst, where quinoline acts as an H₂ acceptor. The integration of these two processes allows for the low temperature direct H₂ transfer, storage, and release using solar light in a scalable manner amenable to other photocatalytic chemical transformations and outer space manufacturing. In an alternative aspect, THQ can be shipped for dehydrogenation at sites of use such as, for example, heavy industry locations or vehicle fueling stations.

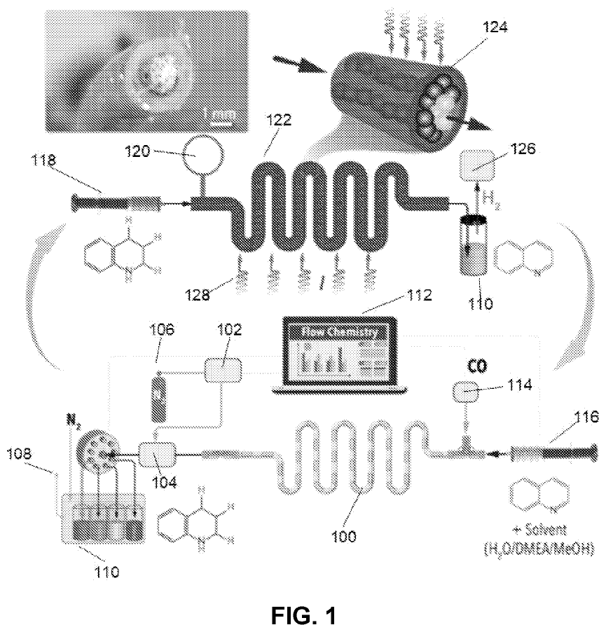

An exemplary hydrogenation/dehydrogenation system is shown in FIG. 1. In a hydrogenation step, quinoline in solvent such as water/DMEA/methanol is injected from syringe or other injection device 116 into segmented flow reactor 100. Separately, carbon monoxide enters the system through mass flow regulator 114. Segmented flow reactor 100 operates at a temperature of 80° C. and a pressure of 350 psig. Tetrahydroquinoline leaves segmented flow reactor 100 through back pressure regulator 104. Nitrogen source 106 travels through digital pressure regulator 102 and enters back pressure regulator 104. Exhaust leaves the system at port 108, while hydrogenated quinoline samples 110 are collected for offline GC-MS analysis. In a dehydrogenation step, tetrahydroquinoline is injected through injector or device 118 into photo flow reactor 122, passing through optional pressure gauge 120 while maintaining a pressure of about 60 psig. Energy input such as light 128 enters the photo flow reactor, converting the tetrahydroquinoline to quinoline. Hydrogen exits the system through flow meter 126 while samples of the reactor effluent 110 can be collected for GC-MS analysis. Computer 112 can be used to control any step in the process and/or to monitor pressure and adjust flow through valves and the like to maintain desired reaction conditions. Cross-section 124 of photo flow reactor 122 shows a flow path for tetrahydroquinoline, where the tetrahydroquinoline can be neat or can be in a solution with a solvent such as, for example, isopropyl alcohol, passing over a Rh/TiO₂ catalyst.

Exemplary reactors for performing the dehydrogenation and/or liquid-gas separation are shown in FIGS. 6A-6B. FIG. 6A shows a reactor constructed from a series of parallel tube reactor beds 208, wherein each tube 208 is packed with a Rh/TiO₂ catalyst. A reflective surface 202 is positioned on one side of the tubes 208. Each tube 208 can have a length A of about 25 cm and can operate at a pressure of from about 1 to about 2000 psi, from about 20 to about 1000 psi, from about 50 to about 400 psi, or from about 25 to about 60 psi. A common feed port 200 can be positioned to allow THQ or another hydrogen source into the reactor. The hydrogen source travels through the reactor beds 208, which are packed with catalyst. Effluent from the tubes including a dehydrogenated molecule such as, for example, quinoline, and a gas being separated such as, for example, H₂, exits through an effluent port 206. If membrane tubes are used, the hydrogen gas bubbles are simultaneously separated from the bed and collected from a separate port. Also present in some embodiments is a catalyst loading port 204 for packing catalyst into the reactor beds FIG. 6B shows an alternate arrangement wherein a flat bottom plate 218 lies under a catalyst channel bed 214, while a top, transparent plate 216 covers the catalyst bed. Feed port 210 and effluent port 212 are also present in this arrangement. The bottom plate 218 is fitted with a catalyst flow resistor in the outlet manifold 220 or the effluent port 212. Holes or slots 222 in the bottom plate 218 lead to the gas-liquid separation membrane sheet 224. The membrane sheet is supported on a perforated or slotted plate that allows gas to flow through the membrane to the gas collection plate 226. The gas effluent port 228 allows the collected gas to flow out of the reactor.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a catalyst,” “a wavelength,” or “a photoreactor bed,” includes, but is not limited to, mixtures, combinations, or groups of two or more such catalysts, wavelengths, or photoreactor beds, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a catalyst refers to an amount that is sufficient to achieve the desired improvement in the property modulated by the formulation component, e.g. achieving the desired level of conversion of THQ to quinoline in a specified time period given conditions including wavelength and intensity of illumination, catalyst identity, flow of solvent or gases through a reactor, pressure, temperature, and the like.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Heterogeneous Photocatalytic Dehydrogenation in Flow

In order to achieve sustainable dehydrogenation of THQ in a photo flow reactor using a heterogeneous catalyst, it is important to achieve low pressure drop (<10 psi/cm) across the reactor to reduce the input energy requirement (i.e., operational cost and carbon footprint) for flowing THQ through the reactor. These investigations of photocatalytic dehydrogenation of THQ were begun in a tube-based photo flow reactor (fluorinated ethylene propylene, FEP, outer diameter: ⅛″, inner diameter: 1/16″) using the Rh/TiO₂ catalyst reported in the batch process developed by Balayeva et al. with 0.2 to 1 wt % Rh loaded on Hombikat TiO₂. Using Hombikat TiO₂ microparticles (ca. 1 μm dia.), packed in the flow reactor, resulted in failure of microreactor fittings due to high pressure drop along the flow reactor (>100 psi/cm at 50 mL/min water flowrate). Using larger TiO₂ microparticles (ground anatase TiO₂, 100-250 μm), decreased the pressure drop in the flow reactor to 30 psi/cm (at 50 mL/min water flowrate), however, frequent system clogging occurred. Larger anatase TiO₂ microparticles (100-250 μm dia.) reduced the pressure drop to 6 psi/cm and maintained continuous water flow for days without clogging.

Next, in-situ Rh loading in the packed-bed photo flow reactor was studied. To achieve 0.2 wt % Rh loading on the large anatase TiO₂ microparticles loaded in the reactor, the void volume of the reactor was purged with argon and then filled with an argon-purged solution of Rh (II) acetate dissolved in 1:2 volume ratio of methanol (MeOH):water (H₂O) under dark conditions. The packed-bed photo flow reactor was then sealed and exposed to UV light (370 nm) for 3 h to allow for photodeposition of Rh on the TiO₂ microparticles in the reactor. The photodeposition process was repeated multiple times to approach the desired Rh loading (0.2 wt %). Following the photodeposition step, the packed-bed photo flow reactor was washed with water (50 mL/min for 8 h) and then dried in a static oven at 110° C. for 12 h. The reactor was cooled and purged with argon before testing for continuous dehydrogenation of THQ. The solution of THQ in IPA (0.1 M) was then continuously fed to the packed-bed photo flow reactor under blue light (427 nm), shown in FIG. 1. The liquid effluent was analyzed by gas chromatography-mass spectrometry (GC-MS) and the gas effluent flow and composition was analyzed by a gas flow meter and gas chromatography-thermal conductivity detector (GC-TCD), respectively (FIG. 1).

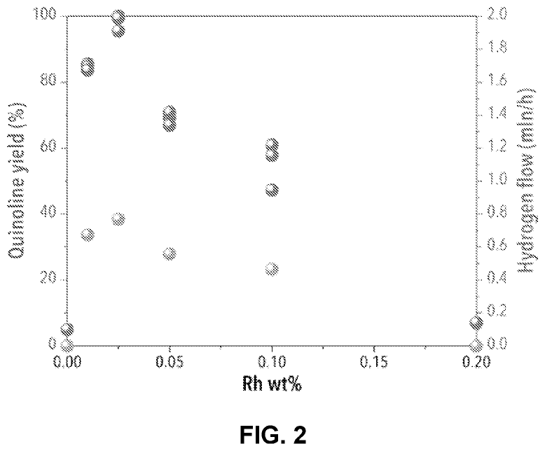

Following the in-situ photodeposition of Rh in the packed-bed photo flow reactor, a quinoline yield of only 7% was obtained, indicating slow kinetics of this heterogeneous catalyst in flow. Moreover, a non-uniform Rh deposition was observed in the flow reactor that was indicated by the formation of a dark gray coating of the reactor walls (i.e., inner surface of the FEP tubing), while the center of the packed-bed reactor remained “blank.” Following this observation, the effect of Rh loading on the in-flow photocatalytic dehydrogenation of THQ was studied and found that the photocatalytic activity monotonically increased as the Rh precursor concentration was decreased, until maximum dehydrogenation yield was achieved at 0.025 wt % Rh/TiO₂ (FIG. 2). The Rh loading lower than 0.025 wt % resulted in a decrease in quinoline yield, and in the absence of Rh, the quinoline yield was limited to only 5%. This behavior can be attributed to the slow H₂ desorption at the lower Rh loading and the decrease in photocatalytic activity by Rh at the higher loading. The optimal Rh loading is significantly lower in flow vs. batch reactor, mainly because of the selective Rh deposition on TiO₂ microparticles near the reactor walls, where the maximum photon flux is absorbed. As the photocatalytic dehydrogenation proceeds, gas bubbles are formed inside the reactor which decrease the liquid residence time and the pressure drop (to less than 2 psi/cm; total 48 psig for a 25 cm-long reactor).

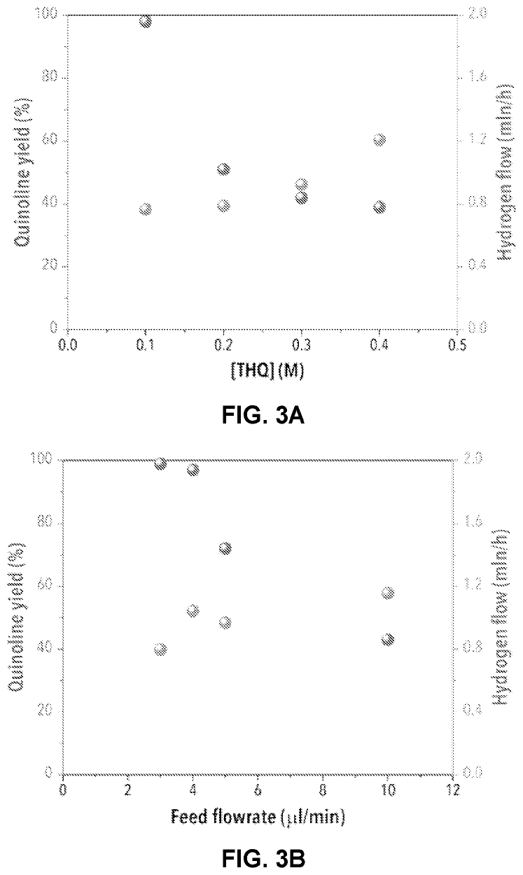

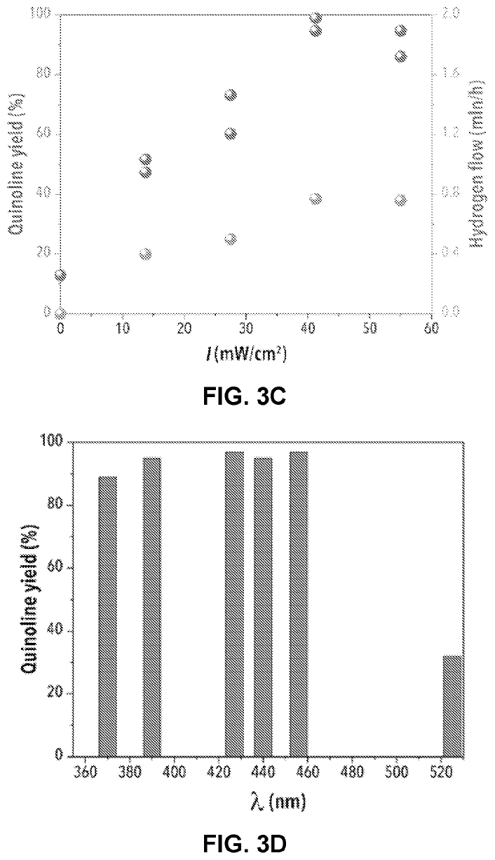

Complete dehydrogenation of THQ to quinoline was achieved when the Rh loading was 0.025 wt %. At this Rh loading, the measured effluent gas flowrate was between 0.78 mln/h and 0.8 mln/h, equivalent to 99.2% to 99.5% of the stoichiometric H₂ flow at 100% quinoline yield. The H₂ flow rate and quinoline yield decrease at Rh loadings higher and lower than the optimal 0.025 wt % loading. The released H₂ flowrate was increased by increasing the THQ concentration at constant liquid flow rate and reactor length, while the quinoline yield was decreased (FIG. 3A). This dichotomy can be explained by the decrease in the liquid residence time and thereby exposure to the effective photon flux in the packed-bed photo flow reactor, due to the formation of H₂ gas segments inside the reactor. When the THQ concentration is doubled, the H₂ flowrate doubles for the same liquid feed flow rate at the same conversion, while the liquid residence time and quinoline yield decrease. At THQ concentration of 0.4 M, the quinoline yield decreased to 39% and the photocatalytically released H₂ flowrate increased to 1.2 mln/h or 96% of the stoichiometric H₂ flow. It should be noted that the selectivity towards quinoline vs. other products decreased from more than 97% to 88% and the pressure drop decreased from 2 psi/cm to 1 psi/cm as the THQ concentration increased from 0.1 M to 0.4 M.

Unlike THQ concentration, increasing the liquid flowrate from 3 μL/min to 4 μL/min, while maintaining the THQ concentration constant at 0.1 M did not result in a significant decrease in the quinoline yield, but increased the released H₂ flowrate to 1 mln/h (FIG. 3B). This can be attributed to the increase in pressure as the liquid velocity increases, and the formation of smaller H₂ gas bubbles at higher pressures. At liquid flow rates higher than 4 μL/min, the quinoline yield decreased to 43% at 10 μL/min and the H₂ flowrate reached 1.15 mln/h. At the THQ flowrate of 10 μL/min, the selectivity towards quinoline over other products remained higher than 97%, but the pressure drop increased to 10 psi/cm.

The geographical location and the weather conditions affect the intensity of the solar light, and thus the dehydrogenation efficiency of the packed-bed photo flow reactor. When the light intensity (I) was lowered to 75% of the maximum intensity of the utilized light source in this study (41 mW/cm²), the quinoline yield and H₂ flowrate remained as high as 95% and 0.77 mln/h, respectively, indicating that the reaction was not limited by the photon flux at/>40 mW/cm² and 0.025 wt % Rh loading (FIG. 3C). At light intensities below 40 mW/cm², the quinoline yield and the H₂ flowrate decreased monotonically until essentially no reaction occurred in the dark (l=0). At maximum light intensity (l=55 mW/cm²), the quinoline yield remained higher than 95% when light sources with peak emission wavelengths (A) of 390 nm, 440 nm, and 456 nm were used. However, a significant decrease of the quinoline yield down to 23% was observed when the light source peak emission wavelength was increased from 456 nm to 525 nm (FIG. 3D).

To elucidate the limiting step in the dehydrogenation reaction, the effect of oxidative vs. inert gas co-injection was studied on the photocatalytic activity and selectivity at 10 μL/min liquid flowrate. The quinoline yield decreased from 39% to 35.1% when argon was co-fed at 25 gas:liquid volumetric ratio (Table 1, entries 1-2). The decrease in the quinoline yield relative to the case when no gas was co-injected could be attributed to the decreased liquid residence time. Replacement of the inert argon with air while keeping the reactor temperature below 30° C. allowed for complete conversion of the 1,2,3,4-THQ, but the selectivity to quinoline was decreased to 85% (Table 1, entries 2-3). The increase in the quinoline conversion at the same light intensity in presence of air suggests that the acceptorless dehydrogenation process is limited by recombinative desorption of H₂ to the gas phase and not the photocatalytic excitation at 0.025 wt % Rh loading. When air is injected, oxygen can react with the surface hydride species to form H₂O₂. When the reaction temperature was increased to 65° C., the conversion of 1,2,3,4-THQ increased from 35.7% to 99.8% (Table 1, entries 2 and 4) indicating a significant reactivity dependence on the reactor temperature. However, the selectivity towards quinoline was decreased with increasing the reactor temperature.

TABLE 1
Photocatalytic Dehydrogenation of 1,2,3,4-THQ in Flow

| | | | | Quinoline |
|---|---|---|---|---|
| Entry | T (° C.) | Gas | 1,2,3,4-THQ Conversion (%) | Yield (%) |
| 1 | 28 | — | 40.2 | 39.0 |
| 2 | 28 | Argon | 35.7 | 35.1 |
| 3 | 28 | Air | 99.9 | 85.5 |
| 4 | 65 | Argon | 99.8 | 95.6 |

0.025 wt % Rh/TiO₂ catalyst.
Photo flow reactor: FEP tubing with an outer diameter of ⅛″, inner diameter of 1/16″, and length of 25 cm.
Inlet liquid flowrate = 10 ml/min.
THQ concentration = 0.1M in IPA.
Gas flow rate = 250 ml/min.
Light source peak emission wavelength = 427 nm.
Light intensity 55 mW/cm²

Batch photocatalytic dehydrogenation reactions were performed to benchmark the performance of the optimized photo flow reactor. The liquid residence time inside the packed-bed photo flow reactor was calculated by measuring the difference in mass between the packed-bed reactor with/without segmented flow (i.e., gas-filled reactor vs. under reaction conditions) and was found to be 2.8 h. A 3-h photocatalytic dehydrogenation reaction in a batch reactor with a Rh loading similar to the optimized loading of the packed-bed photo flow reactor (0.025 wt %) resulted in a quinoline yield of only 11%. Increasing the Rh loading in the batch reactor to 0.25 wt % increased the quinoline yield to 17%. However, further increase of the Rh loading did not result in an increase in the quinoline yield (Table 2). This result is in agreement with the results obtained with Hombikat TiO₂ catalyst, where increasing the Rh loading beyond 0.2 wt % did not have an impact on the photocatalytic reactivity. Increasing the catalyst mass from 10 mg to 50 mg in the batch reactor increased the yield to 23% with the Rh loading of 1 wt % (Table 3). The results shown in Tables 2 and 3 confirm the superior performance of the developed packed-bed photo flow reactor for continuous energy-efficient photocatalytic dehydrogenation with a complete dehydrogenation in 3 h residence time in flow. The slower kinetics of the batch reactor compared to the photo flow reactor is attributable to the photo flux attenuation within 1 mm inside the batch reactor. Utilizing the TiO₂ fine powder (Hombikat, 1 μm dia.) instead of the anatase pellets in the batch reactor increased the quinoline yield to 29% in 3 h. However, this material is not a suitable candidate for packing flow reactors due to the significant increase in the pressure drop caused by the small particle size. Moreover, Rh deposition on a mixed-phase TiO₂ P25 (23% rutile, 77% anatase) was less effective as a dehydrogenation photocatalyst than the pure anatase pellets (Table 2).

TABLE 2
Batch, Photocatlytic Acceptorless Dehydrogenation of
1,2,3,4-Tetrahydroquinoline under an Argon Atmosphere

| | | Rxn | Quinoline |
|---|---|---|---|
| TiO₂ Catalyst | Rh wt % | solvent | Yield (%) |
| Ground pellets (anatase), 100 μm dia | 0.025 | iprOH | 11 |
| Ground pellets (anatase), 100 μm dia | 0.1 | iprOH | 15 |
| Ground pellets (anatase), 100 μm dia | 0.25 | iprOH | 17 |
| Ground pellets (anatase), 100 μm dia | 0.5 | iprOH | 19 |
| Ground pellets (anatase), 100 μm dia | 1 | iprOH | 18 |
| P25 (anatase + rutile) | 1 | iprOH | 9 |
| Hombikat (anatase), 1 μm dia | 1 | iprOH | 29 |
| Ground pellets (anatase), 100 μm dia | 1 | MeOH | 9 |

Catalyst amount = 10 mg, THQ concentration = 0.1M in 1 ml IPA.
Light source peak emission wavelength = 427 nm blue light at 75 mW/cm² intensity, reaction time = 3 h, stir rate = 800 rpm.

TABLE 3
Batch, Photocatalytic Acceptorless Dehydrogenation of
1,2,3,4-Tetrahydroquinoline under n Argon Atmosphere

| 100 μm dia TiO₂ Catalyst mass | | |
|---|---|---|
| (g) | Rxn time (h) | Quinoline Yield (%) |
| 10 | 3 | 18 |
| 20 | 3 | 20 |
| 50 | 3 | 23 |
| 10 | 24 | 73 |
| 10 | 48 | 99 |

Rh wt % = 1, THQ concentration = 0.1M in 1 ml IPA.
Light source peak emission wavelength = 427 nm blue light at 75 mW/cm² intensity, stir speed = 800 rpm.

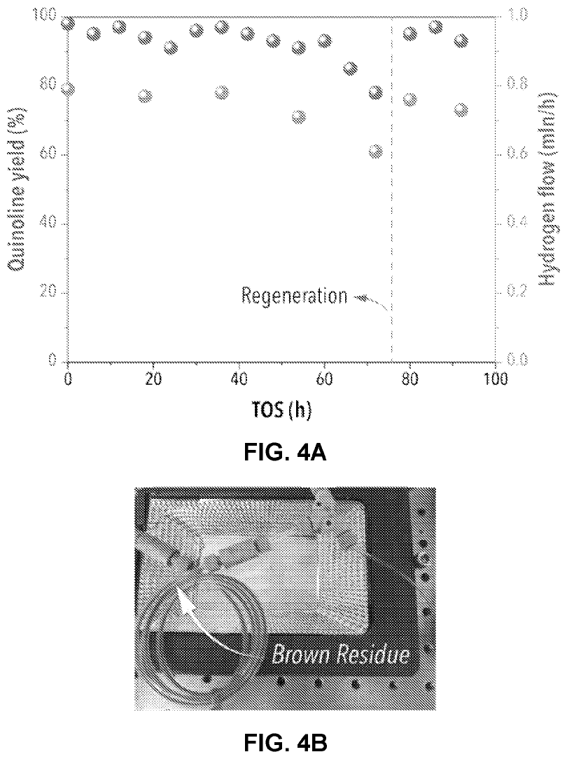

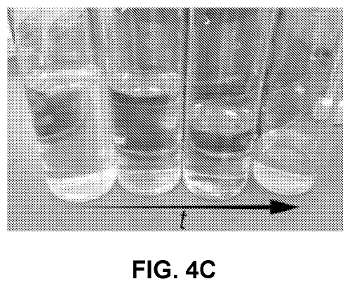

Following the optimization of the packed-bed photo flow reactor, the long-term stability of the reactor and the heterogeneous catalyst over 72 h continuous operation was investigated using 0.1 M THQ in IPA. The quinoline yield and the released H₂ flowrate remained higher than 90% and 0.71 mln/h for the first 60 h, respectively. Catalyst deactivation was observed beyond 60 h time on stream (TOS), and the quinoline yield and H₂ flowrate decreased to 78% and 0.61 mln/h at TOS of 72 h, (FIG. 4A). At this time, a brown residue was deposited on the dehydrogenation catalyst at the inlet side of the flow reactor, potentially because of the photocatalytic coupling that results in the diamine formation (FIG. 4B). The catalyst regeneration in the packed-bed photo flow reactor was performed in situ by flowing an air-water segmented flow under UV illumination (390 nm at/=55 mW/cm²) for 6 h. Under this regeneration condition, degradation, and desorption of catalyst poisons, including diamines occurred as indicated by the GC-MS analysis of the regeneration residue and the strong yellow color of the regeneration water effluent that changed to colorless as the catalyst regeneration proceeded (FIG. 4C). The packed-bed flow reactor was then dried, purged with argon, and the continuous THQ dehydrogenation was continued for another 13 h during which the quinoline yield and H₂ flowrate rebound to 93% and 0.73 mln/h, respectively (FIG. 4A). To verify that the catalyst deactivation was not attributed to Rh leaching, the dehydrogenation liquid product was analyzed by ICP-MS and the Rh concentration was found to be 84.3 μg/L or 0.36 μg/day Rh loss rate under the testing liquid flow rate (i.e., 0.29% of the initial Rh mass/day). The catalyst regeneration water effluent was also analyzed by ICP-MS and the Rh concentration was found to be 64.8 μg/L, indicating a very low leaching under both the reaction and the regeneration conditions.

### Example 2: Quinoline Hydrogenation Under Water-Gas Shift Reaction Conditions

The hydrogenation of quinoline to THQ has been demonstrated to effectively carry out using supported metal nanoparticles, including Rh, Pd, Pt, and Pd alloys. However, the energy needed for molecular H₂ production from water electrolysis or via the WGS reaction raises the cost of energy production/storage. Denmark et al. have recently demonstrated that the WGS can be driven at room temperature with homogeneous Rh catalyst when activated methylene compounds are added as a hydride acceptor. Inspired by this result, the use of quinoline was attempted as a hydride acceptor to lower the temperature of the WGS and allow for the simultaneous H₂ transfer and storage in a single step from water. In the study by Denmark et al., it was demonstrated that the addition of a tertiary amine possessing short alkyl chain is essential to drive the reaction. The amine role in this case is to (1) raise the pH of the medium and maximize the concentration of the OH ions, and (2) ligate the Rh catalyst and suppress the catalyst aggregation in the presence of carbon monoxide (CO).

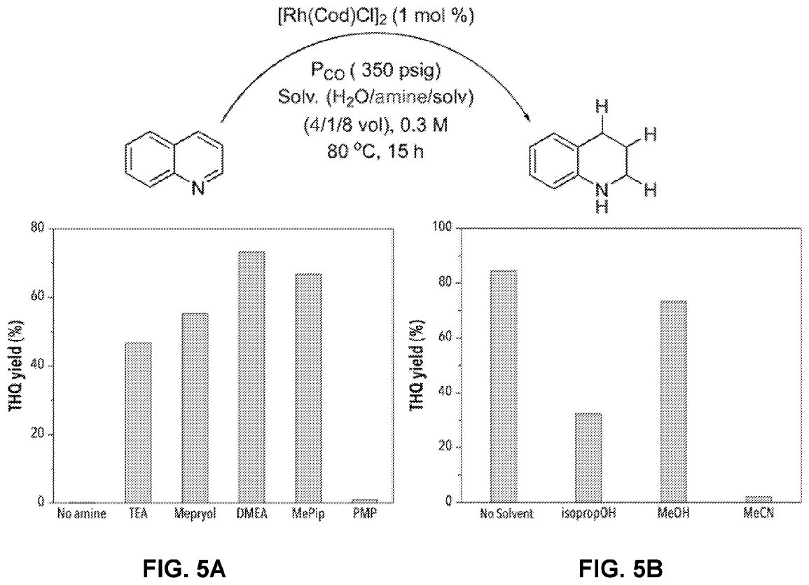

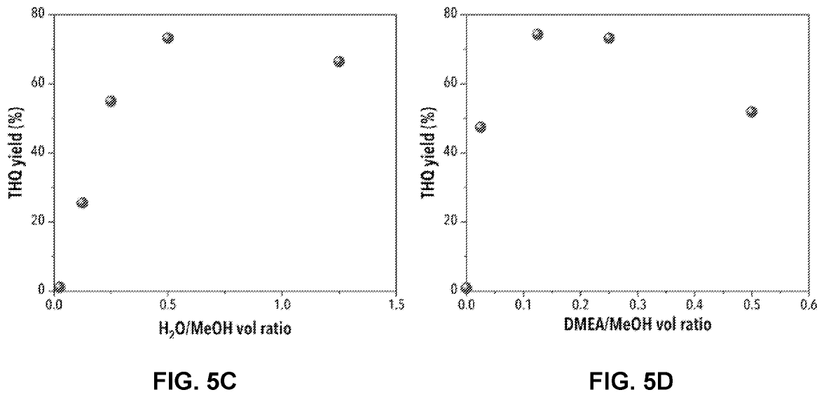

Quinoline and THQ are basic compounds, and thus the WGS reaction can theoretically be carried out without the addition of an auxiliary amine. In an earlier study by Shun-Ichi et al., quinoline hydrogenation under WGS conditions was attempted without the addition of an auxiliary base, but at high temperature (150° C.), high CO pressure (800 psig), and high catalyst loading (4.8 mol. % Rh). At 80° C. and 350 psig CO pressure, no THQ formation was observed after 15 h reaction time in a pressurized batch reactor (FIG. 5A). When triethylamine (TEA) was added to the reaction solvent (MeOH/H₂O) at 0.125:1 amine:MeOH volumetric ratio, the THQ yield increased from 0% to 47% with 2 mol % Rh. Next, the effect of auxiliary amine on the THQ yield was investigated. Replacing TEA with N-methylpyrrolidine (MePryol), dimethylethylamine (DMEA), and N-methylpiperidine (MePip), increased the THQ yield to 55%, 74%, and 67%, respectively. Interestingly, when 1,2,2,6,6-pentamethylpiperidine (PMP) was added as an auxiliary base to the WGS reaction, no THQ was formed, confirming the observation by Denmark et al. regarding the need for non-sterically hindered amine to drive the WGS reaction in presence of a hydride acceptor. Attempting the reaction with dimethylethylamine as an auxiliary amine at 150 psig CO pressure or at room temperature, lowered the THQ yield to 24% and 0%, respectively. Moreover, the quinoline hydrogenation in solvents other than MeOH at 80° C. and 350 psig CO pressure resulted in lower THQ yields (FIG. 5B). Contrary to the hydrogenation reaction, isopropanol was found to be a better solvent than methanol in the dehydrogenation reaction (Table 2). Hydrogenation by the WGS reaction was found to be dependent on the solvent polarity-similar to the results reported by Denmark et al.—which could explain the observed decrease in THQ yield with isopropanol as the solvent. The decrease in the quinoline yield when methanol was utilized as a solvent in the dehydrogenation step could be attributed to the formation of stable surface methoxides that blocks the Lewis acid sites or the decomposition of methanol to form carbon monoxide that can poison the Rh catalytic sites.

The optimal DMEA and water volumetric ratio relative to MeOH was found to be 0.125 and 0.5, respectively (FIGS. 5C-5D). At lower amine or water volumetric ratios, the medium pH and the OH-concentration are reduced which result in slower reaction rates. At higher amine or water volumetric ratios, the reaction slows down because of the catalyst and reactant dilution. As the reaction proceeds, carbon dioxide (CO₂) is produced and captured by the amine solution in the form of ammonium bicarbonate that results in a decrease in the medium pH and an increase in the medium ionicity. The latter effect causes the separation of the post reaction mixture to organic layer that mainly contains the THQ in MeOH and the aqueous layer that contains the free amine, ammonium bicarbonate, and water in MeOH. Attempting to perform the WGS reaction in a segmented flow reactor by co-feeding the reaction liquid solution with CO gas (FIG. 1) did not result in an increase in the reaction rate, indicating that the reaction is not limited by CO diffusion into the liquid phase at 350 psig (see Table 4). The ability to continuously generate stored H₂ in continuous flow reactors allows for steady operation and maximizes the area to volume ratio for enhanced heat and mass transfer.

TABLE 4
Batch versus Segmented Flow Reactor for the Hydrogenation
of Quinoline to 1,2,3,4-Tetrahydroqunoline under Water-
Gas Shift Conditions in 4 h Liquid Residence Time

| Reactor | 1,2,3,4-THQ Yield (%) |
|---|---|
| Batch | 19 |
| Segmented flow (Gas:Liquid volumetric ratio = | 22 |
| 1:1) | |

0.3M quinoline hydrogenation under the WGS conditions in MeOH solvent at 80° C., 350 psig CO pressure, 0.125/1 DMEA/MeOh vol. ratio, and 1 mol % [Rh(COD)Cl]₂.

The ability to significantly decrease the reaction temperature, pressure, and Rh loading upon the addition of the optimal amount of the auxiliary amine and water, drastically lowers the energy required for H₂ production and storage from water. At 80° C. reaction temperature, the reaction can be conveniently driven by a solar thermal collector such as a parabolic trough.

Replacing the Rh dimer [Rh(COD)Cl]₂ with the monomeric Rh(COD)₂BF₄ catalyst at the same complex loading (cutting the Rh loading by half) resulted in a decrease in the 1,2,3,4-THQ yield from 74.3% to 54.3% (Table 5). Additive screening with the monomeric Rh catalyst showed that the yield can be increased to 66% with the addition of benzoic acid. When the acid is added to the DMEA solution, it forms the ammonium benzoate dissolved salt which increases the ionic strength of the aqueous solution and results in a separation of the quinoline-containing organic layer. Under the CO atmosphere, the Rh carbonyl species preferentially accumulate in the organic layer and thus, the effective catalyst concentration in the reaction medium is raised. Increasing the Rh(COD)₂BF₄ catalyst loading to 1.5 mol % in the presence of 50 mol % benzoic acid resulted in a 94% THQ yield in 15 h at 80° C. with no side products.

TABLE 5
Additives Screening for the Hydrogenation of Quinoline
to 1,2,3,4-Tetrahydroquinoline under Water-Gas Shift
Reaction Conditions Rh(Cod)₂BF₄ (1 mol % Rh)

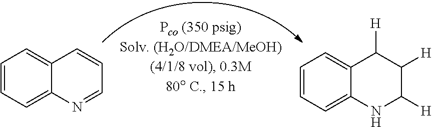 [SMILES: c1ccc2ncccc2c1 ; c1ccc2c(c1)CCCN2]

| Additive | 1,2,3,4-THQ Yield (%) |
|---|---|
| — | 54.3 |
| CsI 5 mol % | 55.2 |
| CsBr 4 mol % | 58.2 |
| KI 2.6 mol % | 51.0 |
| LiCl 14 mol % | 57.0 |
| Benzoic acid 100 mol % | 66.1 |

0.3M quinoline hydrogenation under the WGS reaction
conditions in MeOH solvent at 80° C.,
350 psig CO pressure, and 1 mol % [Rh(COD)Cl]₂.

### CONCLUSIONS

In conclusion, a sustainable and energy-efficient photocatalytic strategy for continuous and selective acceptorless dehydrogenation of THQ in a transparent photo flow reactor packed with heterogeneous Rh/anatase TiO₂ catalyst was demonstrated. Post-packing Rh deposition on TiO₂ microparticles by UV photoreduction allowed for the selective Rh deposition in the fraction of the packed-bed reactor where photoexcitation occurs and lowered the optimal Rh loading to a fraction of what is needed when Rh photoreduction is carried out in a batch reactor. The developed packed-bed photo flow reactor allowed for on-site continuous, high purity H₂ production. The released H₂ flow rate could be maximized by increasing the THQ concentration, or the liquid feed flowrate. The dehydrogenation activity increased with light intensity until it reached its maximum at 40 mW/cm². Furthermore, simultaneous H₂ production from water and storage in quinoline was enabled in a single step at 80° C. and 350 psig CO pressure when dimethylethylamine was added as an auxiliary amine to the WGS reaction. The combination of these two processes allows for a drastic reduction in the energy penalty required for H₂ production and storage and suppresses the CO₂ emissions involved in clean fuel production. The heterogeneous photo flow reactor reported in this study will find applications in a wide range of other photocatalytic reactions as well as outer space manufacturing. Moreover, the developed quinoline hydrogenation/dehydrogenation technology allows for efficient long duration energy storage.

### Example 3: Methods

### Photocatalytic THQ Dehydrogenation in Flow

A 25 cm Teflon tubing (FEP), inner diameter (ID): 1/16″, outer diameter (OD): ⅛″) was packed with TiO₂ ground pellets and fitted with 1 μm PEEK frits. The tube was purged with argon and the solution of Rh (II) acetate was continuously fed to the packed-bed flow reactor using a syringe pump and then the reactor was exposed to UV LED. Next, DI water was injected to wash the catalyst and then the reactor was dried in a drying oven. (See Supplementary Section for details). A solution of THQ in anhydrous IPA was then continuously fed to the reactor at the desired liquid flow and the reactor was illuminated with a 427 nm LED at a light intensity of 60 mW/cm², unless otherwise mentioned. The reactor temperature was monitored with a thermocouple and maintained below 30° C. by flowing cold air between the coil and the LED from a Peltier cooler. As the dehydrogenation occurred in the flow reactor, gas bubbles were formed which resulted in a gas-liquid segmented flow leaving the reactor. The effluent leaving the packed-bed photo flow reactor was directed to a sealed vial with a septum cap where gas-liquid separation was performed. The gas stream was routed through the septum to a bubble flow meter to measure the gas flowrate, while 100 μL samples were frequently taken from the collected liquid at the outlet for analysis by GC-MS.

### Photodeposition and Dehydrogenation in a Batch Reactor

The desired amount of the dried Rh/TiO₂ was weighed in an 8 ml glass vial and a stir bar was added. A solution of THQ in anhydrous IPA was prepared at the desired concentration (0.1 M) and added to the vial. The vial was then capped with a septum cap. The slurry solution was purged with argon for 1 h and the sealed vial was placed on a stir plate (800 rpm) and illuminated by a 427 nm LED at a light intensity of 60 mW/cm². The vial temperature was monitored with a thermocouple and maintained below 30° C. by flowing cold air between the reactor and the LED from a Peltier cooler. An aluminum foil layer was placed on the non-illuminated side of the glass vial to maximize light absorption by the photocatalyst from all sides. The reaction was run for 24 h. An aliquot was then then filtered through a celite bed and analyzed by GC-MS.

### Analysis of the Effluent During the Regeneration of the Packed-Bed Reactor

A segmented flow of DI water/air was fed to the bed at 50 μL/min and 0.2 mln/min, respectively, using a syringe pump (HARVARD PHD ULTRA) and a mass flow controller (EL-Flow®, Bronkhorst). The packed-bed photo flow reactor was illuminated by UV LED (390 nm at/=55 mW/cm²) for 6 h, while the segmented flow was moving through the reactor to affect catalyst poisons degradation and desperation. The initial fraction of the effluent water was pumped down under vacuum and the residue was analyzed by GC-MS. The detected mass was 262 m/z, indicating the formation of diamine products that can potentially bind strongly on the surface and inhibit the reaction.

### Hydrogenation of Quinoline Under WGS Conditions in a Segmented Flow Reactor

An 8 mL stainless steel syringe connected to a Teflon tubing (FEP, OD: 1/16″, ID: 0.01″) was filled with the reaction solution containing the catalyst, solvent, water, amine and quinoline and the liquid was fed to the reactor coil using a syringe pump. Gas-liquid segmentation was achieved by contacting the liquid stream with the CO gas flow in a stainless steel T-junction (⅛″ OD, Swagelok) before entering the stainless-steel flow reactor (OD: ⅛″, ID: 1/16″, and 94 cm length. Gas flowrate was controlled by a mass flow controller (EL-Flow®, Bronkhorst). The segmented flow reactor temperature was controlled using a hotplate and oil bath with a temperature probe immersed in the oil bath. The flow reactor pressure was controlled with a backpressure regulator (Equilibar) integrated at the outlet of the flow reactor. Product analysis was performed by GC-MS.

### Hydrogenation of Quinoline Under WGS Conditions in a Batch Reactor

The reaction was performed in a Buchi Tinyclave pressure vessel. A solution of [Rh(COD)Cl]₂ was prepared in anhydrous methanol and added to a 4 mL glass vial with a stir bar. The DI water, amine, and quinoline were added to the vial. The vial was transferred to the pressure vessel and pressurized to the desired pressure (350 psig unless otherwise mentioned), then placed on a hot stir plate (80° C., 800 rpm). The hydrogenation reaction was conducted for 15 h. The pressure vessel was then cooled down, vented, and purged with N2 before opening. An aliquot was taken from the organic layer for analysis by GC-MS.

### Example 4: Additional Experimental Details

### Materials and Methods

Solid particles having an average diameter of 250 μm were packed in the channel plate photoreactor described in FIG. 6B. In this reactor, 10 channels are connected to one inlet and one effluent manifold. Each channel has a length of 25 cm and the width is 8 mm. The channel depth is 3 mm. Water containing methylene blue dye was injected into the reactor at variable flowrates and the measured pressure drop across the reactor at each flow rate is listed in Table 6. In this example, the solid particles filled the inlet and outlet manifolds and the catalyst flow resistor was a glass wool mesh fitted at the effluent port of the reactor. In another example, a perforated mesh was fitted at the outlet manifold to keep the manifold clear of particles and the pressure drop at 10 ml/min was 0.6 bar. The transparent window for this reactor allowed 99% visible light transmission and can withstand up to 12 bar internal pressure.

TABLE 6
Liquid flow and pressure drop in a channel plate
photoreactor packed with 250 micrometer particles

| Liquid flowrate (mL/min) | Pressure drop (bar) |
|---|---|
| 10 | 7 |
| 7 | 3.5 |
| 5 | 2 |
| 3 | 1 |
| 1 | 0.5 |

100 μL of the reaction samples collected from either batch or flow reactors were diluted with 1 mL of toluene and 100 μL of 0.05 M 1,3,5-trimethoxybenzene in toluene as an internal calibration standard. 1 μL of the GC mixture was injected into a Shimadzu GCMS-2010 with a Zebron ZB-5MSi column (30 m×0.25 mm×0.25 μm). Gas purity analysis was performed by injecting samples collected in gas tight syringes to an Agilent 6890 GC-TCD unit equipped with a Hayesep 10 packed column. IPC-MS was performed on Thermo Scientific iCAP RQ ICP-MS. Liquid samples were prepared by removing the organic materials under high vacuum (15 mbar and 80° C.) and dissolving the residue in HCl/HNO₃ solution before injecting the samples. Solid samples were digested in concentrated HCl/HNO₃ solution, then filtered before analysis.

GC-MS was carried out for 15 min at 150° C. Component calibration was performed on quinoline and 1,2,3,4-tetrahydroquinoline relative to the internal standard.

### Fabrication of the Packed-Bed Photo Flow Reactor

Anatase TiO₂ pellets (Fisher) were crushed and sieved. The fraction between 100 μm-250 μm was collected and washed with water three times to remove “sticking” fine powders. The washed TiO₂ particles were then dried at 110° C. in a drying oven. The dried TiO₂ particles were transferred to a 40 mL glass vial with a silicon septum cap. The cap was punctured and a 25 cm Teflon tubing (fluorinated ethylene propylene (FEP), inner diameter (ID): 1/16″, outer diameter (OD): ⅛″), fitted with a 1 μm PEEK frit (IDEX Health & Sciences) on one side, was inserted through the punctured septum from the non-fritted side. The vial was flipped and shaken by hand to allow the TiO₂ particles to freely flow through the tube towards the frit. After packing the flow reactor, the tube was taken out of the septum and fitted with another 1 μm PEEK frit on the other side. The amount of the TiO₂ particles inside the tube was ca. 500 mg as calculated by two methods from the difference in both the tube and the vial weights before and after packing, the weights measured by the two methods matched to +2%. The packed tube was gently curved to form a coil to be illuminated by the light emitting diode (LED) light source. When deionized (DI) water was flown through the packed-bed flow reactor at 50 μL/min, the pressure drop was ca. 150 psig and the flow could be maintained for extended period of time without clogging or fitting failure. When TiO₂ Hombikat or Degussa P25 were used for packing the reactor, the pressure drop was significantly increased and resulted in failure of the reactor fittings.

### In-Situ Rh Photodeposition

The desired amount of Rh (II) acetate was weighed in a glass vial and methanol and water were added at 2:1 volumetric ratio. The vial was capped with a septum cap and purged with argon for 1 h to remove oxygen. Then, an 8 ml stainless steel syringe was filled with the Rh solution under argon. At the same time, the packed-bed photo flow reactor was purged with 1 mln/min argon for 1 h using a mass flow controller (EL-Flow®, Bronkhorst). The Rh precursor solution was continuously fed to the packed-bed flow reactor using a syringe pump (Harvard PHD ULTRA) at 50 μL/min, while the outlet side of the reactor was capped to prevent air from leaking in. The packed-bed flow reactor was covered during the precursor injection to prevent non-uniform Rh deposition. After filling the packed-bed flow reactor with the solution, the flow was stopped, the valve (IDEX Health & Sciences) on the inlet side was closed, and then the reactor was exposed to UV LED (370 nm, I=60 mW/cm²) for 3 h. The flow reactor temperature was maintained at below 30° C. by flowing cold air between the reactor and the LED from a Peltier cooler. An aluminum foil layer was placed on the non-illuminated side of the reactor to maximize photon absorption by the packed-bed photo flow reactor from all sides. The outlet valve was slowly opened to release the pressure of the built-up gas without disturbing the packing. Next, the inlet valve was opened, and DI water was injected at 50 μL/min for 8 h. Following this step, the packed-bed photo flow reactor was dried in a drying oven at 110° C. for 12 h.

### Photocatalytic THQ Dehydrogenation in Flow

The dried packed-bed photo flow reactor was purged with argon and allowed to cool down to room temperature. A solution of THQ in anhydrous IPA was prepared at the desired concentration (0.1 M unless otherwise mentioned) and the solution was purged with argon. An 8 mL stainless steel syringe was filled with the THQ solution under argon, loaded on a syringe pump (HARVARD PHD ULTRA), and connected to the reactor. The THQ precursor was then continuously fed to the reactor at the desired liquid flow rate (3 μL/min unless otherwise mentioned). The packed-bed photo flow reactor was illuminated with a 427 nm LED at a light intensity of 60 mW/cm², unless otherwise mentioned. The reactor temperature was monitored with a thermocouple and maintained below 30° C. by flowing cold air between the reactor coil and the LED from a Peltier cooler. As the dehydrogenation reaction occurred in the flow reactor, gas bubbles were formed which resulted in a gas-liquid segmented flow leaving the reactor. The effluent leaving the packed-bed photo flow reactor was directed to a sealed vial with a septum cap, where gas-liquid separation was performed. The gas stream was routed through the septum to a bubble flow meter to measure the gas flowrate, while 50 μL samples were frequently taken from the collected liquid at the outlet for analysis by GC-MS.

### Photodeposition and Dehydrogenation in a Batch Reactor

The desired amount of Rh (II) acetate was weighed in a glass vial and methanol and water were added at 2:1 volumetric ratio. The vial was capped with a septum cap and purged with argon for 1 h to remove oxygen. Anatase TiO₂ pellets (Fisher) were crushed and sieved. The fraction between 100 μm-250 μm was collected and washed with water. The washed TiO₂ particles were then dried at 110° C. in a drying oven. The dried TiO₂ particles were transferred to a 40 mL glass vial with a magnetic stir bar and capped with a silicon septum cap. The Rh solution was transferred to the vial containing the TiO₂ particles. Then, the vial was purged with argon for another 1 h and sealed. The vial was placed on a stir plate (400 rpm) and illuminated by an LED light source (370 nm, l=60 mW/cm²) for 24 h. The vial temperature was maintained at below 30° C. by flowing cold air between the flow reactor coil and the LED from a Peltier cooler. An aluminum foil layer was placed on the non-illuminated side of the vial to maximize photon absorption by the vial from all sides. After 24 h, the slurry was poured into a double layer filter paper for solid phase recovery. However, only about 40% of the initial TiO₂ mass was recovered on the filter paper because of excessive particles crushing to fines in the batch photo reactor. The slurry was combined and speared by centrifugation instead. The solid residue was washed with DI water and separated by centrifugation four times to remove surface alkoxides or acetates. The solids were then dried in a drying oven at 110° C. for 12 h. Each washing step resulted in some mass loss and the overall TiO₂ mass recovery after drying was 85%. A gray to black layer of Rh was also formed on the glass vial wall indicating the non-desired Rh deposition on the wall of the batch photoreactor. Rh deposition on Hombikat and P25 TiO₂ was performed following the same procedure.

The desired amount of the dried Rh/TiO₂ was weighed in an 8 mL glass vial and a stir bar was added. A solution of THQ in anhydrous IPA was prepared at the desired concentration (0.1 M) and added to the vial. The vial was then capped with a septum cap. The slurry solution was purged with argon for 1 h and the sealed vial was placed on a stir plate (800 rpm), and illuminated by a 427 nm LED at a light intensity of 60 mW/cm². The vial temperature was monitored with a thermocouple and maintained below 30° C. by flowing cold air between the reactor and the LED from a Peltier cooler. An aluminum foil layer was placed on the non-illuminated side of the glass vial to maximize light absorption by the photocatalyst from all sides. The reaction was conducted for 24 h. An aliquot was then then filtered through a celite bed and analyzed by GC-MS.

### Regeneration of the Packed-Bed Photo Flow Reactor

To regenerate the photocatalyst packed in the photo flow reactor, a segmented flow of DI water/air was fed to the bed at 50 μL/min and 0.2 mln/min, respectively, using a syringe pump (HARVARD PHD ULTRA) and a mass flow controller (EL-Flow®, Bronkhorst). The packed-bed photo flow reactor was illuminated by UV LED (390 nm at/=55 mW/cm²) for 6 h, while the gas-liquid segmented flow was moving through the reactor to affect catalyst poisons degradation and desperation. The collected effluent water was a dark yellow color and gradually went to colorless as the regeneration process proceeded. The initial fraction of the effluent water was pumped down under vacuum and the residue was analyzed by GC-MS. The detected mass was 262 m/z, indicating the formation of diamine products that can potentially bind strongly on the surface and inhibit the reaction. The bed was then dried in a drying oven at 110° C. for 12 h. The dried packed-bed photo flow reactor was cooled under argon to room temperature before re-injecting the THQ in IPA solution to continue the photocatalytic dehydrogenation process.

### Hydrogenation of Quinoline Under WGS Conditions in a Batch Reactor

A solution of [Rh(COD)Cl]₂ was prepared in anhydrous methanol and added to a 4 ml glass vial with a stir bar. The DI water, amine, and quinoline were added to the vial. The vial was then sealed with a silicon septum cap and punctured with two needles to allow for facile gas exchange without excessive solvent evaporation inside the pressure vessel. The vial was then transferred to a pressure vessel (Buchi Tinyclave). The pressure vessel was sealed and purged with nitrogen three times. The pressure vessel was purged with carbon monoxide (CO), pressurized to the desired pressure (350 psig unless otherwise mentioned), and placed on a hot stir plate (80° C., 800 rpm). The hydrogenation reaction was conducted for 15 h. The pressure vessel was then cooled down, vented, and purged with nitrogen before opening. An aliquot was taken from the organic layer for analysis by GC-MS.

### Hydrogenation of Quinoline Under WGS Conditions in a Segmented Flow Reactor

The catalyst [Rh(COD)Cl]₂ was dissolved in methanol and then DI water, dimethylethyl amine, and quinoline were added. An 8 mL-stainless steel syringe connected to a Teflon tubing (FEP, OD: 1/16″, ID: 0.01″) was filled with the reaction mixture under inert atmosphere. The syringe outlet was capped under inert atmosphere with a Teflon screw cap (IDEX Health & Science) before being transferred outside of the glovebox. The stainless steel syringe was then connected to a PEEK fitting (IDEX Health & Science). Gas-liquid segmentation was achieved by contacting the liquid stream with the CO gas flow in a stainless steel T-junction (⅛″ OD, Swagelok) before entering the stainless-steel flow reactor (OD: ⅛″, ID: 1/16″, and 94 cm length). Liquid flowrate was controlled by a syringe pump (Harvard PHD ULTRA) and gas flowrate was controlled by a mass flow controller (EL-Flow®, Bronkhorst). The segmented flow reactor temperature was controlled using a hotplate and oil bath with a temperature probe immersed in the oil bath. The flow reactor pressure was controlled with a backpressure regulator (Equilibar) integrated at the outlet of the flow reactor. The flow reactor effluent was passed through a 10-way selector valve (VICI, EUHB) and directed to a custom-designed sample collection chamber equipped with an exhaust line for the unreacted CO. Prior to the in-flow WGS hydrogenation reaction, the fluidic path, including the feed lines, and discharge lines were rinsed with 16 mL methanol, then dried with nitrogen flow. After changing reaction conditions, the flow reactor was allowed to stabilize for two residence times before a sample was collected by directing the selector valve towards a collection vial. Following the sample collection, the flow reactor effluent was directed to the waste collection vial during the transient period of the next reaction condition. Product analysis was performed by GC-MS. The liquid residence time was set at 4 h and the quinoline yield was 22%, which is similar to the yield obtained in the batch reactor (19%) after the same reaction time under the same reaction conditions (80° C., and 350 psig CO pressure).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Aas, N., et al. Adsorption and decomposition of methanol on TiO2, SrTiO3 and SrO. J. Chem. Soc., Faraday Trans. 90, 1015-1022, (1994).
2. Balayeva, N. O., et al. Rh/TiO2-Photocatalyzed Acceptorless Dehydrogenation of N-Heterocycles upon Visible-Light Illumination. ACS Catal. 10, 5542-5553 (2020).
3. Balayeva, N. O., et al. Visible-Light-Mediated Photocatalytic Aerobic Dehydrogenation of N-heterocycles by Surface-Grafted TiO2 and 4-amino-TEMPO. ACS Catal. 9, 10694-10704 (2019).
4. Buglioni, L., et al. Technological Innovations in Photochemistry for Organic Synthesis: Flow Chemistry, High-Throughput Experimentation, Scale-up, and Photoelectrochemistry. Chem. Rev., 122, 2752-2906 (2022).
5. Chee, S. W., et al. Structural changes in noble metal nanoparticles during CO oxidation and their impact on catalyst activity. Nat. Commun. 11, 2133, (2020).
6. Crabtree, R. H. Hydrogen storage in liquid organic heterocycles. Energy Environ. Sci. 1, 134-138 (2008).
7. Cui, X. et al. Acceptorless dehydrogenation and hydrogenation of N- and O-containing compounds on Pd3Au1 (111) facets. Sci. Adv. 6, eabb3831 (2020).
8. Denmark, S. E., et al. Room Temperature, Reductive Alkylation of Activated Methylene Compounds: Carbon-Carbon Bond Formation Driven by the Rhodium-Catalyzed Water-Gas Shift Reaction. ACS Catal. 7, 613-630 (2017).
9. Deraedt, C., et al. Dendrimer-Stabilized Metal Nanoparticles as Efficient Catalysts for Reversible Dehydrogenation/Hydrogenation of N-Heterocycles. J. Am. Chem. Soc. 139, 18084-18092 (2017).
10. Dutta, S. A review on production, storage of hydrogen and its utilization as an energy resource. J. Ind. Eng. Chem. 20, 1148-1156 (2014).
11. Eskander, S. M. S. U. et al. Reduction in greenhouse gas emissions from national climate legislation. Nat. Clim. Change. 10, 750-756 (2020).
12. Gong, X. et al. Metal-Organic Frameworks for the Exploitation of Distance between Active Sites in Efficient Photocatalysis. Angew. Chem. Int. Ed. 59, 5326-5331 (2020).
13. Jaiswal, G., et al. Iron-based nanocatalyst for the acceptorless dehydrogenation reactions. Nat. Commun. 8, 2147 (2017).
14. Kothandaraman, J. et al. Efficient Reversible Hydrogen Carrier System Based on Amine Reforming of Methanol. J. Am. Chem. Soc. 139, 2549-2552 (2017).
15. Moores, A., et al. Catalysed low temperature H₂ release from nitrogen heterocycles. New J. Chem. 30, 1675-1678 (2006).
16. Navlani-García, M., et al. Recent strategies targeting efficient hydrogen production from chemical hydrogen storage materials over carbon-supported catalysts. NPG Asia Materials 10, 277-292 (2018).
17. Sambiagio, C. et al. Flow Photochemistry: Shine Some Light on Those Tubes! Trends Chem. 2, 92-106 (2020).
18. Sánchez-Delgado, R. A., et al. Hydrogenation of quinoline by ruthenium nanoparticles immobilized on poly(4-vinylpyridine). Catal. Commun. 8, 2115-2118 (2007).
19. Shun-Ichi, M., et al. Rhodium Catalyzed Hydrogenation of Quinolines and Isoquinolines under Water-Gas Shift Conditions. Bull. Chem. Soc. Jpn. 62, 2968-2976, (1989).
20. Tan, K. C., et al. Recent Advances of Catalysis in the Hydrogenation and Dehydrogenation of N-Heterocycles for Hydrogen Storage. J. Phys. Chem. C 125, 18553-18566 (2021).
21. van Renssen, S. The hydrogen solution? Nat. Clim. Change. 10, 799-801 (2020).
22. Wang, Q., et al. Strategies to improve light utilization in solar fuel synthesis. Nat. Energy, 7, 13-24 (2022).
23. Weidenthaler, C. et al. Solid-state hydrogen storage for mobile applications: Quo Vadis? Energy Environ. Sci. 4, 2495-2502 (2011).
24. Weinstein, L. A. et al. Concentrating Solar Power. Chem. Rev. 115, 12797-12838 (2015).
25. Zhao, J. et al. AuPt bimetallic nanoalloys supported on SBA-15: A superior catalyst for quinoline selective hydrogenation in water. Nano Research, 15, 1796-1802 (2022).
26. Zheng, M., et al. Metal-Free Dehydrogenation of N-Heterocycles by Ternary h-BCN Nanosheets with Visible Light. Angew. Chem. Int. Ed. 57, 5487-5491 (2018).
27. Zhu, Q.-L. et al. Liquid organic and inorganic chemical hydrides for high-capacity hydrogen storage. Energy Environ. Sci. 8, 478-512 (2015).

1. A continuous flow packed-bed photoreactor for gas-liquid separation, the photoreactor comprising:
at least one photoreactor bed comprising a material transparent to UV and visible light;
a liquid inlet;
a catalyst flow resistor; and
a gas outlet;
wherein the at least one photoreactor bed is packed with a heterogeneous photocatalyst.

2. The photoreactor of claim 1, wherein the at least one photoreactor bed comprises at least one channel.

3. The photoreactor of claim 2, further comprising a top plate and a bottom plate, wherein the top plate comprises the material transparent to UV and visible light and can withstand up to 30 bar internal pressure.

4. The photoreactor of claim 3, wherein the bottom plate comprises the at least one channel, and wherein the at least one channel is packed with the heterogeneous photocatalyst.

5. The photoreactor of claim 3, further comprising a gas permeable membrane disposed on a membrane support.

6. The photoreactor of claim 1, wherein the at least one photoreactor bed comprises a tube.

7. The photoreactor of claim 6, wherein the tube comprises a gas permeable transparent membrane.

8. The photoreactor of claim 6, wherein the photoreactor comprises a plurality of identical photoreactor beds arranged in parallel.

9. The photoreactor of claim 9, further comprising a first manifold chamber connecting the liquid inlet to a photoreactor bed inlet for each individual photoreactor bed of the plurality.

10. The photoreactor of claim 10, further comprising a second manifold chamber connecting a photoreactor bed outlet for each individual photoreactor bed of the plurality to the liquid effluent.

11. The photoreactor of claim 1, further comprising a reflective material on one side of the photoreactor.

12. The photoreactor system of claim 1, further comprising a gas collection chamber.

13. The photoreactor of claim 10, wherein the catalyst flow resistor is located inside the second manifold chamber connecting the photoreactor beds to the outlet.

14.-49. (canceled)
